(19) United States
(12) Patent Application Publication
(10) Pub. No.: US 2019/0270294 A1
(43) Pub. Date: Sep. 5, 2019

(54) SILICON CONTAINED INTEGRATED STRUCTURE AND THE METHOD FOR FORMING THE SAME

(71) Applicant: WEN YAO CHANG, Taipei City (TW)

(72) Inventor: WEN YAO CHANG, Taipei City (TW)

(21) Appl. No.: 15/908,839

(22) Filed: Mar. 1, 2018

(51) Int. Cl. B32B 37/12; B32B 7/12; B32B 25/10; B32B 25/20

(52) U.S. Cl. CPC B32B 37/1207; B32B 7/12; B32B 25/10; B32B 2437/00; B32B 2037/1215; B32B 2307/7265; B32B 25/20

(57) ABSTRACT

A silicon contained integrated structure and the method for forming the same is proposed, wherein a hot melt glue layer is adhered under a silicon layer. The hot melt glue layer contains a high temperature hot melt glue layer and a low temperature hot melt glue layer. By the high temperature hot melt glue layer, the hot melt glue layer may be combined to the silicon layer, while the low temperature hot melt glue layer cause the whole structure can be combined to an object, such as cloth. Furthermore, the present invention uses silicon as material. It can be formed as various specific shapes by molding manufacturing and then the silicon integrated sheet can be transferred to cloth. The whole process is quick and cost is low. Moreover, silicon is not deformed due to heat and thus it has lower effect to the environment than other conventional used material.

### FIELD OF THE INVENTION

The present invention is related to silicon applications, and in particular to a silicon contained integrated structure and the method for forming the same.

### BACKGROUND OF THE INVENTION

Conventionally, to form trademarks, slogans, and other drawings on clothes, plastic materials are used to cut into desired shapes, and then the material is heated and melted to combine to clothes. Generally, the melting points of plastics are low and thus they easily volatile to release plasticizers and other halogen compounds under high temperature. The plasticizers and halogen compounds are harmful to human body. Clothes are worn on human body for a long time and thus the plasticizers and halogen compounds will permeate into human skin or breath into interiors of bodies so as to affect human health. Furthermore, the plasticizers and halogen compounds are easy to oxidize and thus become yellow to affect outlook and lifetime of clothes.

Due the defect of conventional clothes using plastic materials for trademarks or other drawings, European union and other developing countries have planned to inhibit to use plastic materials on clothes for forming trademarks or other drawings. Silicon is highly stably and do not deform in high temperature environments under 150 degree C. Therefore, silicon is good material for replacing plastics in attaching to clothes.

Conventionally, liquid silicon is ejected on cloth. Each time, only a small bit of silicon is injected and thus for forming a drawing on the clothes, the whole operation time is long. After ejection, the cloth with silicon is baked. Then the cloth is adhered to clothes by seaming or adhering. The defect of this way is that it cannot be made with molding process and thus the process is made one by one. Furthermore the injection of silicon material to cloth is very slow. Therefore, the whole manufacturing time is very long and more labors are necessary. Moreover, the cost is high and thus this way is seldom used.

If it is desired to attach silicon to clothes, the problem is that the silicon is melted in a very high temperature, while under this temperature, the clothes will melt or destroyed. Thus, silicon is not proper to be adhered to clothes directly.

Therefore, the object of the present invention is to provide a method which can result the above mentioned defects in the prior art.

### SUMMARY OF THE INVENTION

To improve above mentioned defects in the prior art, the present invention provide silicon contained integrated structure and the method for forming the same is proposed, wherein a hot melt glue layer is adhered under a silicon layer. The hot melt glue layer contains a high temperature hot melt glue layer and a low temperature hot melt glue layer. By the high temperature hot melt glue layer, the hot melt glue layer may be combined to the silicon layer, while the low temperature hot melt glue layer cause the whole structure can be combined to an object, such as cloth. Furthermore, the present invention uses silicon as material. It can be formed as various specific shapes by molding manufacturing and then the silicon integrated sheet can be transferred to cloth. The whole process is quick and cost is low. Moreover, silicon is not deformed due to heat and thus it has lower effect to the environment than other conventional used material.

To achieve above object, the present invention provides a silicon contained integrated structure, comprising:

a silicon layer;

a hot melt glue layer;

a high temperature hot melt glue layer below the silicon layer and adhered to the silicon layer by using bridging agent;

a low temperature hot melt glue layer adhered below the high temperature hot melt glue layer;

wherein the high temperature hot melt glue layer is formed by heating hot melt glue in a first forming temperature; the low temperature hot melt glue layer is formed by heating hot melt glue in a second forming temperature; and the second forming temperature is lower than the first forming temperature;

Furthermore, method for forming a silicon integrating sheet capable of being adhered to an object is proposed, wherein the method comprises steps of:

melting a first batch of hot melt glue under a first forming temperature so as to form a thin sheet of high temperature hot melt glue layer; then a second batch of hot melt glue is melted under a second forming temperature so as to form a thin sheet of low temperature hot melt glue layer; in that the second forming temperature is lower than the first forming temperature;

combining the high temperature hot melt glue layer to the low temperature hot melt glue layer so as to form as a hot melt glue layer; wherein the high temperature hot melt glue layer is located at an upper side and the low temperature hot melt glue layer is at a lower side; because the high temperature hot melt glue layer and the low temperature hot melt glue layer have different forming temperatures and thus they have the different physical properties; the upper high temperature hot melt glue layer is melted in the first forming temperature and the low temperature hot melt glue layer is melted in the second forming temperature;

coating a layer of bridging agent on an upper side of the high temperature hot melt glue layer and then a layer of silicon material being coated on the bridging agent; and

heating an upper side of the whole hot melt glue layer to a first forming temperature so as to melt an upper surface of the high temperature hot melt glue layer and thus the bridging agent being melted; the bridging agent will cause the hot melt glue on the upper surface of the high temperature hot melt glue layer to melt and then permeates into the silicon material; as a result, the high temperature hot melt glue layer is combine with the silicon material; wherein when temperature is reduced gradually the silicon material will form as a silicon layer.

### BRIEF DESCRIPTION OF THE DRAWINGS

FIG. 1 is a combinational schematic view of the present invention.

FIG. 2 is a schematic view about the high temperature hot melt glue layer and the low temperature hot melt glue layer according to the present invention.

FIG. 3 is a schematic view showing the hot melt glue layer of the present invention which is formed by combination of the high temperature hot melt glue layer and the low temperature hot melt glue layer.

FIG. 4 is a schematic view showing bridging agent being coated on the high temperature hot melt glue layer and silicon material being coated on the bridging agent according to the present invention.

FIG. 5 is a schematic view showing the heating process on the upper side of the hot melt glue layer according to the present invention.

FIG. 6 is a schematic view showing the combination of the silicon layer, sticky zone, high temperature hot melt glue layer and the low temperature hot melt glue layer.

FIG. 7 shows the manufacturing process according to the present invention.

FIG. 8 is a schematic view showing the combination of the silicon layer, the hot melt glue layer and the object according to the present invention.

FIG. 9 shows one application that the silicon layer and the hot melt glue layer are integrated to an object according to the present invention.

FIG. 10 shows another application that the silicon layer and the hot melt glue layer are integrated to an object according to the present invention.

FIG. 11 shows another embodiment of the present invention.

FIG. 12 shows a further embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

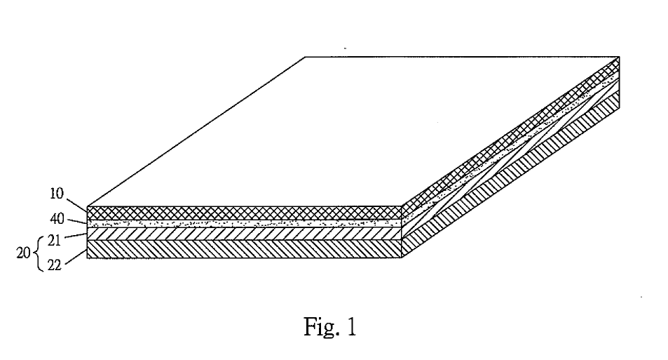

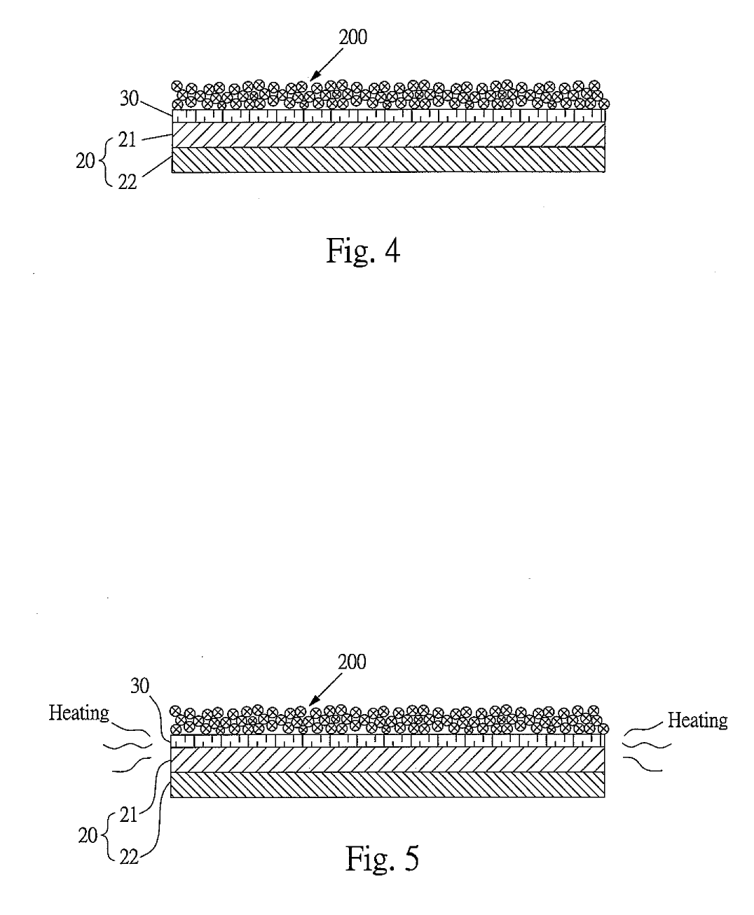

With reference to FIGS. 1 to 12, the silicon integrated sheet of the present invention is illustrated. The silicon integrated sheet includes the following elements.

A silicon layer 10 is included.

A hot melt glue layer 20 (as illustrated in FIG. 1) comprises the following elements.

A high temperature hot melt glue layer 21 is below the silicon layer 10 and is adhered to the silicon layer 10 by using bridging agent.

A low temperature hot melt glue layer 22 is adhered below the high temperature hot melt glue layer 21.

The high temperature hot melt glue layer 21 is formed by heating hot melt glue under a first forming temperature. The low temperature hot melt glue layer 22 is formed by heating another hot melt glue under a second forming temperature. The second forming temperature is lower than the first forming temperature.

A gluing zone 40 is formed between the high temperature hot melt glue layer 21 and the silicon layer 10. The material of the gluing zone 40 is mainly mixed by the high temperature hot melt glue layer 21, the silicon layer 10 and the bridging agent.

Preferably, material of the bridging agent is polysiloxan. Preferably, material of the hot melt glue layer 20 is thermoplastic polyurethane.

The first forming temperature is between 120° C. to 200° C., and the second forming temperature is between 60° C. to 150° C. The first forming temperature is greater than the second forming temperature with a gap between 10° C. to 60° C.

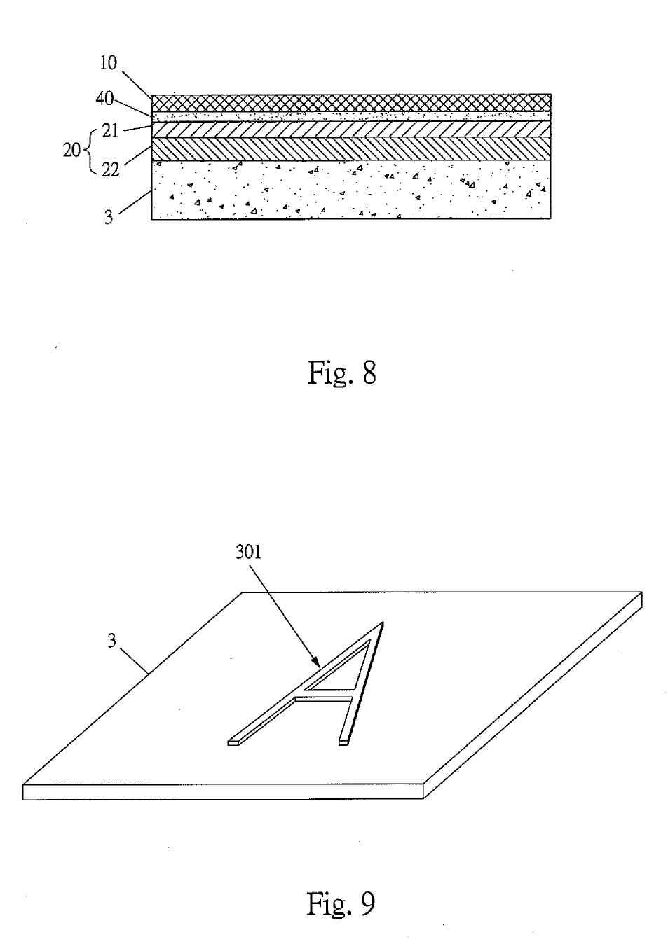

As shown in FIG. 8, the present invention further comprises an object layer 3 which is below the low temperature hot melt glue layer 22. The object layer 3 is not melt or has no unacceptable deformation under the second forming temperature. The way for combination is that the structure of the silicon layer 10 with the hot melt glue layer 20 is hot-melted and then is adhered to the object layer 3, wherein the material of the silicon layer 10 with the hot melt glue layer 20 is heated to the second forming temperature so that the low temperature hot melt glue layer 22 is melted and then is combined to the object layer 3.

With reference to FIG. 9, the structure of the silicon layer 10 with the hot melt glue layer 20 is cut to have a specific shape 301 and then the structure with the specific shape 301 is adhered to the object layer 3. The specific shape 3 may be one of textures, trademarks, advertisement contents, alert sentences, etc.

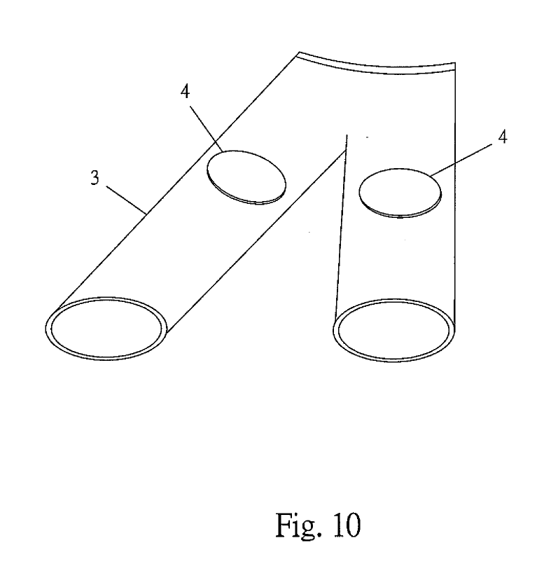

With reference to FIG. 10, after the structure 4 of the silicon layer 10 with the hot melt glue layer 20 is adhered to the object layer 3. The structure 4 is used for water proof or anti-sliding.

Preferably, material of the object layer 3 is selected from cloth, rubbers, metals, plastics, etc. It is more preferably, the cloth is a part of clothes.

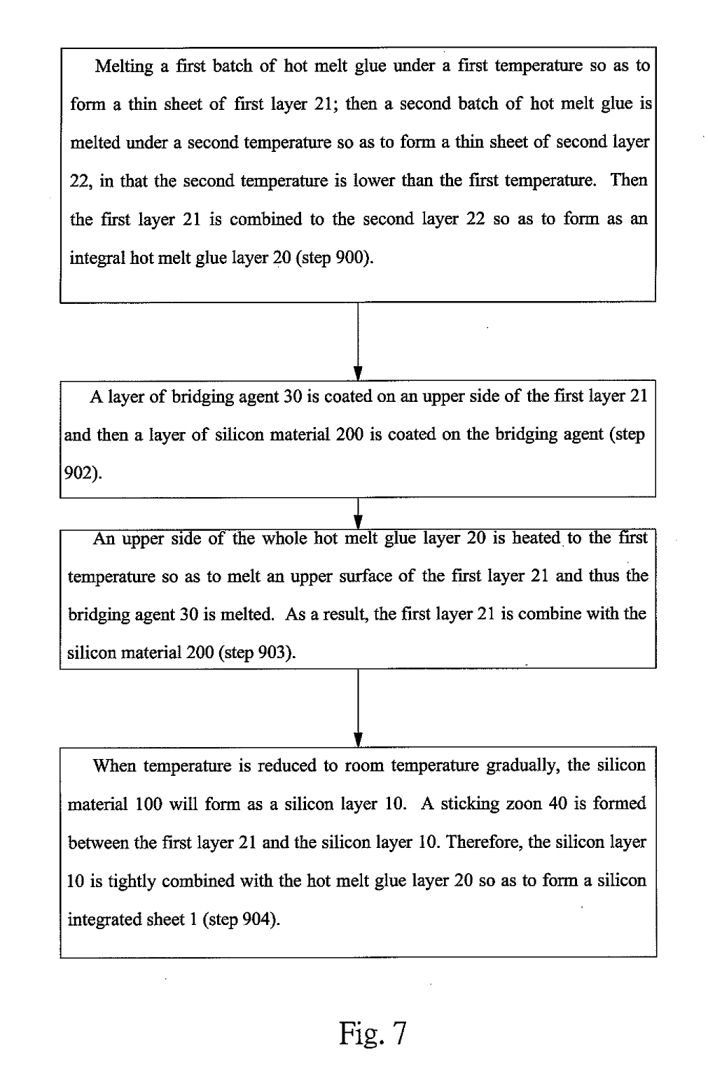

Referring to FIG. 7, the method for forming in integrated silicon sheet according to the present invention will be described herein.

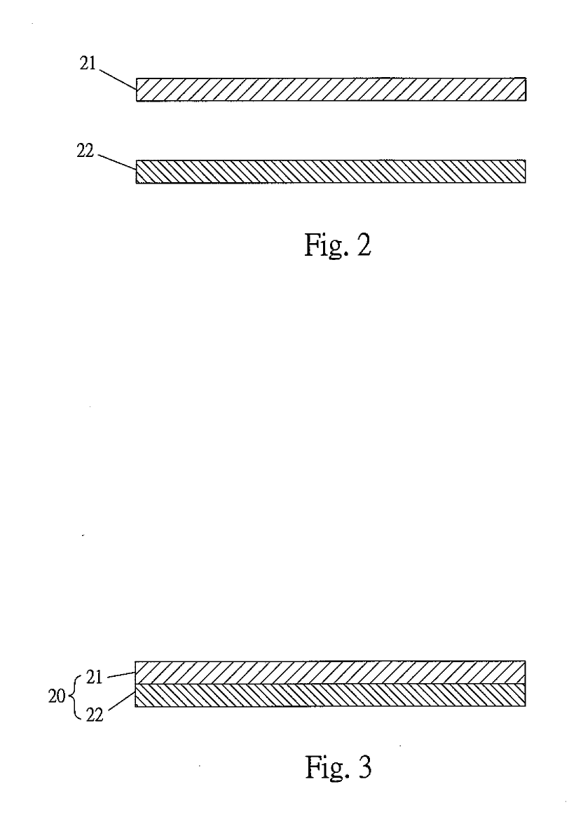

Melting a first batch of hot melt glue under a first forming temperature so as to form a thin sheet of high temperature hot melt glue layer 21; then a second batch of hot melt glue is melted under a second forming temperature so as to form a thin sheet of low temperature hot melt glue layer 22 (referring to FIG. 2), in that the second forming temperature is lower than the first forming temperature. Then the high temperature hot melt glue layer 21 is combined to the low temperature hot melt glue layer 22 so as to form as an integral hot melt glue layer 20 (referring to FIG. 3). The high temperature hot melt glue layer 21 is located at an upper side and the low temperature hot melt glue layer 22 is at a lower side (step 900), wherein the first forming temperature is between 120° C. to 200° C., and the second forming temperature is between 60° C. to 150° C. The first forming temperature is greater than the second forming temperature with a gap between 10° C. and 60° C.

In above process, the high temperature hot melt glue layer 21 and the low temperature hot melt glue layer 22 may be formed individually and then the two layers are combined. Or the high temperature hot melt glue layer 21 is formed firstly, and then hot melt glue is filled on a surface of the high temperature hot melt glue layer 21 and then they are heated to a second forming temperature so as to form the low temperature hot melt glue layer 22. Thus, the whole hot melt glue layer 20 is formed.

Because the high temperature hot melt glue layer 21 and the low temperature hot melt glue layer 22 have different forming temperatures and thus they have the different physical properties although all they are formed by hot melt glue. The upper high temperature hot melt glue layer 21 is melted in the first forming temperature and the low temperature hot melt glue layer 22 is melted in the second forming temperature.

A layer of bridging agent 30 is coated on an upper side of the high temperature hot melt glue layer 21 and then a layer of silicon material 200 is coated on the bridging agent, as illustrated in FIG. 2 (step 902). Preferably, material of the bridging agent is polysiloxan. Preferably, material of the hot melt glue layer 20 is thermoplastic polyurethane.

Next, an upper side of the whole hot melt glue layer 20 is heated to the first forming temperature (referring to FIG. 5) so as to melt an upper surface of the high temperature hot melt glue layer 21 and thus the bridging agent 30 is melted. The bridging agent 30 will cause the hot melt glue on the upper surface of the high temperature hot melt glue layer 21 to melt and then permeates into the silicon material 200. As a result, the high temperature hot melt glue layer 21 is combine with the silicon material 200 (step 903).

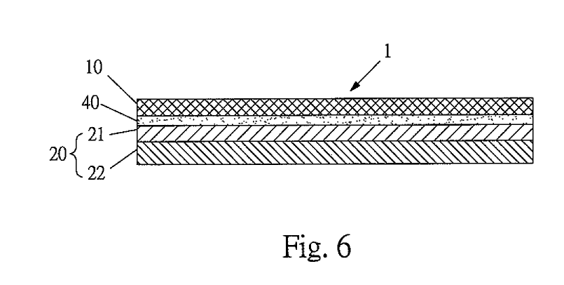

When temperature is reduced to room temperature gradually, the silicon material 100 will form as a silicon layer 10 (referring to FIG. 6). A sticking zoon 40 is formed between the high temperature hot melt glue layer 21 and the silicon layer 10. The sticky zoon 40 is mainly formed by original materials in the high temperature hot melt glue layer 21, the silicon material 200 and the bridging agent 30. Therefore, the silicon layer 10 is tightly combined with the hot melt glue layer 20 so as to form a silicon integrated sheet 1 with abilities of heat melting and heat combination (step 904).

The main application of the present invention is mainly that the silicon integrated sheet 1 is adhered to a desired object by heat melting, wherein the object is not melted and deformed in the second forming temperature.

The method is to heat the silicon integrated sheet 1 to the second forming temperature so that the low temperature hot melt glue layer 22 at a lower side of the silicon integrated sheet 1 is melted and thus to combined with the object under the second forming temperature, while other materials in the silicon integrated sheet 1 do not melt and do not deform to an unacceptable level. Thus the material in the silicon integrated sheet 1 is not destroyed.

In many applications of the present invention, the silicon integrated sheet 1 may be combined with cloth.

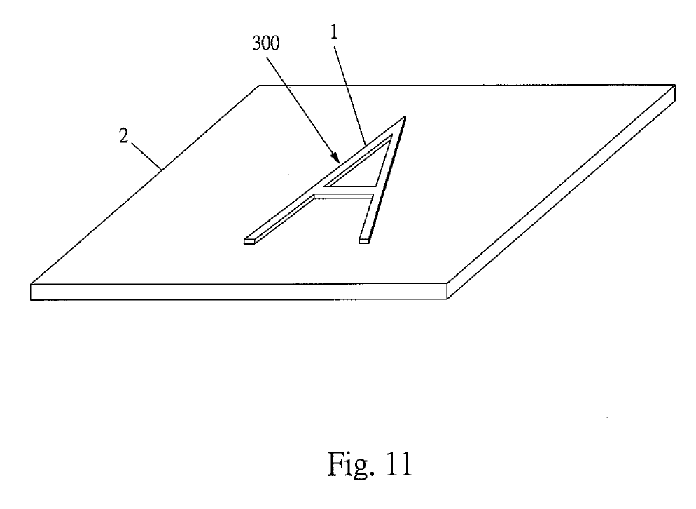

In one embodiment, the silicon integrated sheet 1 is cut to a specific shape 300 (referring to FIG. 11), the shape may have a form of textures, trademarks, advertise contents, alerts, etc. Then under the second forming temperature, the low temperature hot melt glue layer 22 of the silicon integrated sheet 1 is melted and then combined to the object 2 so that the whole silicon integrated sheet 1 with the specific shape 300 is combined to the object 2. Preferably, material of the object 2 may be cloth, rubber, metal, plastics, etc. Optimum, the cloth is a part of cloth of clothes.

This application is helpful to make a trademark or an indication on a clothes. This is a main manufacturing process in making of clothes.

In the present invention, the process for combination of the silicon integrated sheet 1 to an object 2 may be used to other manufacturing process.

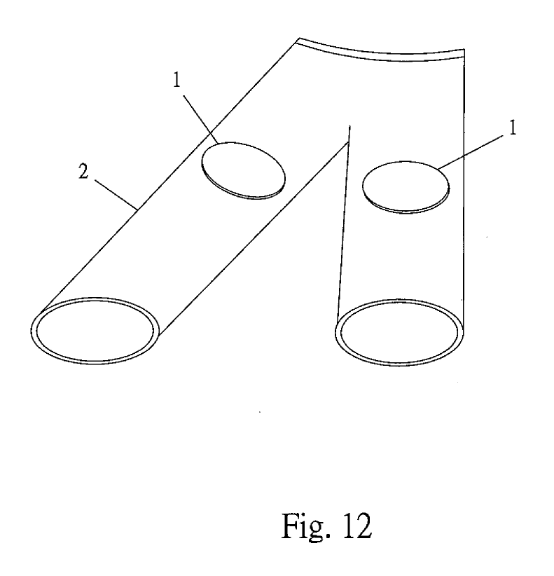

As shown in FIG. 12, in another embodiment, the silicon integrated sheet 1 is cut to have a specific shape and is combined to an object 2 according to the process shown in the description about FIG. 11. The object 2 is preferably selected from cloth, rubber, metal and plastics, etc. Optimum the cloth is a part of cloth of clothes. The main function of the structure shown in FIG. 12 is aimed to waterproof or anti-slide. This is because silicon has the function of waterproof and anti-slide so that the structure shown in FIG. 12 may be adhered to a proper portion to have the function of water proof or slide proof.

The primary feature of the present invention is that a hot melt glue layer is adhered under a silicon layer. The hot melt glue layer contains a high temperature hot melt glue layer and a low temperature hot melt glue layer. By the high temperature hot melt glue layer, the hot melt glue layer may be combined to the silicon layer, while the low temperature hot melt glue layer cause the whole structure can be combined to an object, such as cloth. As a result, the present invention resolves the problem incurred in the prior art, that is, the silicon cannot directly combine with cloth. Furthermore, the present invention uses silicon as material. It can be formed as various specific shapes by molding manufacturing and then the silicon integrated sheet can be transferred to cloth. The whole process is quick and cost is low. Moreover, silicon is not deformed due to heat and thus it has lower effect to the environment than other conventional used material. Therefore, many governments accept to use silicon to replace other plastics.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A silicon contained integrated structure, comprising:
a silicon layer;
a hot melt glue layer;
a high temperature hot melt glue layer below the silicon layer and adhered to the silicon layer by using bridging agent;
a low temperature hot melt glue layer adhered below the high temperature hot melt glue layer;
wherein the high temperature hot melt glue layer is formed by heating hot melt glue in a first forming temperature; the low temperature hot melt glue layer is formed by heating hot melt glue in a second forming temperature; and the second forming temperature is lower than the first forming temperature.

2. The silicon contained integrated structure as claimed in claim 1, wherein a gluing zone is formed between the high temperature hot melt glue layer and the silicon layer; materials of the gluing zone is mixture of the high temperature hot melt glue layer, the silicon layer and the bridging agent.

3. The silicon contained integrated structure as claimed in claim 1, wherein a material of the bridging agent is polysiloxan.

4. The silicon contained integrated structure as claimed in claim 1, wherein a material of the hot melt glue layer is thermoplastic polyurethane.

5. The silicon contained integrated structure as claimed in claim 1, wherein the first forming temperature is between 120° C. to 200° C., and the second forming temperature is between 60° C. to 150° C.; the first forming temperature is greater than the second forming temperature with a gap between 10° C. to 60° C.

6. The silicon contained integrated structure as claimed in claim 1, further comprising an object layer which is below the low temperature hot melt glue layer; wherein the object layer is not melt or has no unacceptable deformation under the second forming temperature; and
wherein a way for combination of the high temperature heat melting glue layer and the low temperature heat melting glue layer is that the structure of the silicon layer with the hot melt glue layer is hot-melted and then is adhered to the object layer, wherein the material of the silicon layer with the hot melt glue layer is heated to the second forming temperature so that the low temperature hot melt glue layer is melted and then is combined to the object layer.

7. The silicon contained integrated structure as claimed in claim 1, wherein the structure of the silicon layer with the hot melt glue layer is cut to have a specific shape and then the structure with the specific shape is adhered to the object layer as an integral object.

8. The silicon contained integrated structure as claimed in claim 7, wherein the specific shape is one of textures, trademarks, advertisement contents, alert sentences.

9. The silicon contained integrated structure as claimed in claim 7, wherein the integral object has functions of water proof and anti-sliding.

10. The silicon contained integrated structure as claimed in claim 7, wherein a material of the object layer is selected from cloth, rubbers, metals, plastics.

11. A method for forming a silicon integrating sheet capable of being adhered to an object, comprising steps of:
melting a first batch of hot melt glue under a first forming temperature so as to form a thin sheet of high temperature hot melt glue layer; then a second batch of hot melt glue is melted under a second forming temperature so as to form a thin sheet of low temperature hot melt glue layer; in that the second forming temperature is lower than the first forming temperature;
combining the high temperature hot melt glue layer to the low temperature hot melt glue layer so as to form as a hot melt glue layer; wherein the high temperature hot melt glue layer is located at an upper side and the low temperature hot melt glue layer is at a lower side; because the high temperature hot melt glue layer and the low temperature hot melt glue layer have different forming temperatures and thus they have the different physical properties; the upper high temperature hot melt glue layer is melted in the first forming temperature and the low temperature hot melt glue layer is melted in the second forming temperature;
coating a layer of bridging agent on an upper side of the high temperature hot melt glue layer and then a layer of silicon material being coated on the bridging agent; and
heating an upper side of the whole hot melt glue layer to a first forming temperature so as to melt an upper surface of the high temperature hot melt glue layer and thus the bridging agent being melted; the bridging agent will cause the hot melt glue on the upper surface of the high temperature hot melt glue layer to melt and then permeates into the silicon material; as a result, the high temperature hot melt glue layer is combine with the silicon material; wherein when temperature is reduced gradually the silicon material will form as a silicon layer.

12. The method as claimed in claim 11, wherein a sticking zoon is formed between the high temperature hot melt glue layer and the silicon layer; the sticky zoon is mainly formed by materials in the high temperature hot melt glue layer, the silicon material and the bridging agent.

13. The method as claimed in claim 11, wherein the high temperature hot melt glue layer and the low temperature hot melt glue layer are formed individually and then the two layers are combined.

14. The method as claimed in claim 11, wherein the high temperature hot melt glue layer is formed firstly, and then hot melt glue is filled on a surface of the high temperature hot melt glue layer and then they are heated to a second forming temperature so as to form the low temperature hot melt glue layer.

15. The method as claimed in claim 11, wherein a material of the bridging agent is polysiloxan.

16. The method as claimed in claim 11, wherein a material of the hot melt glue layer is thermoplastic polyurethane.

17. The method as claimed in claim 11, wherein the first forming temperature is between 120° C. to 200° C., and the second forming temperature is between 60° C. to 150° C.; the first forming temperature is greater than the second forming temperature with a gap between 10° C. to 60° C.

18. The method as claimed in claim 11, further comprising a step of attaching an object layer to be below the low temperature hot melt glue layer; wherein the object layer is not melt or has no unacceptable deformation under the second forming temperature; and
wherein a way for combination of the high temperature heat melting glue layer and the low temperature heat melting glue layer is that the structure of the silicon layer with the hot melt glue layer is hot-melted and then is adhered to the object layer, wherein the material of the silicon layer with the hot melt glue layer is heated to the second forming temperature so that the low temperature hot melt glue layer is melted and then is combined to the object layer.

19. The method as claimed in claim 11, wherein the structure of the silicon layer with the hot melt glue layer is cut to have a specific shape and then the structure with the specific shape is adhered to the object layer as an integral object.

20. The silicon contained integrated structure as claimed in claim 19, wherein the specific shape is one of textures, trademarks, advertisement contents, alert sentences.
